(19) United States
(12) Patent Application Publication
(10) Pub. No.: US 2004/0005112 A1
(43) Pub. Date: Jan. 8, 2004

(54) Electronic device having a diffusion barrier region including aluminum and a method of manufacture therefor

(75) Inventors: Michael Geva, Sierra Madre, CA (US); Jayatirtha N. Holavanahalli, Macungie, PA (US); Abdallah Ougazzaden, Breinigsville, PA (US); Lawrence E. Smith, Macungie, PA (US)

Correspondence Address: HITT GAINES P.C., P.O. BOX 832570, RICHARDSON, TX, 75083, US

(73) Assignee: TriQuint Technology Holding Co., Hillsboro, OR

(21) Appl. No.: 10/611,483

(22) Filed: Jul. 1, 2003

Related U.S. Application Data
(63) Continuation of application No. 09/757,099, filed on Jan. 8, 2001.

(51) Int. Cl. G02B 6/26

(52) U.S. Cl. 385/16

(57) ABSTRACT

The present invention provides an electronic device having superior qualities. The electronic device includes an active region located over a substrate and an undoped layer located over the active region. The electronic device further includes a doped upper cladding layer located over the undoped layer, wherein a diffusion barrier region including aluminum is located between the undoped layer and the doped upper cladding layer. In an exemplary embodiment of the invention, the diffusion barrier region is a diffusion barrier layer or a number of diffusion barrier layers located between a plurality of the undoped layers.

### CROSS-REFERENCE TO RELATED APPLICATIONS

This application is a continuation of U.S. patent application Ser. No. 09/757,099, entitled “ELECTRONIC DEVICE HAVING A BARRIER REGION INCLUDING ALUMINUM AND A METHOD OF MANUFACTURE THEREFOR”, filed on Jan. 8, 2001. The above-listed application is commonly assigned with the present invention and is incorporated herein by reference as if reproduced herein in its entirety.

### TECHNICAL FIELD OF THE INVENTION

The present invention is directed, in general, to an electronic device and, more specifically, to an electronic device having a diffusion barrier region including aluminum that substantially prevents zinc diffusion, and a method of manufacture thereof.

### BACKGROUND OF THE INVENTION

Optical fibers are key components in modern telecommunications and have gained wide acceptance. As is well known, telecommunication optical fibers are thin strands of glass capable of transmitting an optical signal containing a large amount of information over long distances with very low loss. Single fibers can carry multiple packets of data that are multiplexed on the fiber either by time division, where different slots of time are allocated to different packets, or by wave division multiplexing, where different wavelengths are allocated for different data. Optoelectronic devices, such as modulators and switches, perform the important function of adding information content to optical signals in optical communications systems. Such devices may include epitaxially grown multi quantum well type structures of an indium phosphide (InP) or indium gallium arsenic phosphide (InGaAsP) base. The quantum well type structures may be undoped, or may be doped with various n-type and p-type dopants.

The precision placement of the p-n junction in the active regions of optoelectronic devices is critically important for meeting the increasingly stringent requirements on device performance, such as modulation bandwidth, output power, extinction ratio, and uncooled operation. Zinc is presently the most commonly used p-type dopant in cladding and contact layers of various optoelectronic devices. These zinc layers are typically, but not necessarily, grown last, after active regions and blocking structures of the optoelectronic device have already been formed. Due to the high temperatures used to epitaxially grow layers by metalorganic vapor phase epitaxy (MOVPE), large amounts of zinc currently diffuse into the active region of the device. This zinc diffusion is highly undesirable because it can cause a shift of emitting wavelengths (up to tenths of microns) and reshaping of the zinc distribution profile. Moreover, the excess zinc in the active region may result in degradation of device characteristics, such as extinction ratio and junction capacitance in electroabsorbtion modulator structures.

One way the optoelectronic device manufacturing industry has attempted to substantially reduce the zinc diffusion into the active region is to epitaxially form an undoped zinc set-back above the active region prior to forming the zinc doped upper layer. The undoped zinc set-back, if manufactured correctly, is capable of substantially reducing the zinc diffusion into the active area. However, a problem with the zinc set-back layer is that its optimal thickness is sensitive to the structure parameters (such as doping level and thickness) and growth conditions (growth rate and temperature) of the zinc-doped and contact layers. Thus, the zinc set-back layer needs to be customized for each device structure and reactor, which is time consuming and costly. Furthermore, the zinc set-back layer does not provide an adequate control, i.e., not reproducible, over the shape of the final zinc distribution in the upper layer, and may be considered very thick (e.g., up to about

1000 nm), which may undesirably move a p-n junction from the active region.

Another attempt the optoelectronic device manufacturing industry has made to substantially reduce the zinc diffusion problems is to incorporate beryllium, instead of zinc, above the active region. Beryllium, which is a P-type dopant when included within indium phosphide, has a lower diffusion coefficient than zinc. However, a problem with the use of beryllium arises in that there is currently no appropriate metal-organic chemical vapor deposition (MOCVD) or MOVPE deposition process for beryllium. Moreover, beryllium has an extremely low incorporation efficiency, requiring an increased amount of time and money to include within the optoelectronic device.

Another way the optoelectronic device manufacturing industry has attempted to substantially reduce the zinc diffusion problems, is to incorporate a highly silicon-doped layer between the zinc doped upper layer and the active region. This method tends to prevent the zinc from diffusing into the active region; however, the effectiveness of the silicon doping layer is very sensitive to the silicon doping level and the layer thickness. In addition, silicon is an n-type dopant and when included between the upper layer and the active device, it may form an additional, unwanted, p-n junction above the active region. This is generally undesirable as well, because it may degrade the device's electrical characteristics.

Accordingly, what is needed in the art is an electronic device that does not encounter the problems associated with the prior art electronic devices, and more specifically, an electronic device, and a method of manufacture therefor, that prevents the diffusion of dopants into the active device regions.

### SUMMARY OF THE INVENTION

To address the above-discussed deficiencies of the prior art, the present invention provides an electronic device having superior qualities. The electronic device includes an active region located over a substrate and an undoped layer located over the active region. The electronic device further includes a doped upper cladding layer located over the undoped layer, wherein a diffusion barrier region including aluminum is located between the undoped layer and the doped upper cladding layer. In an exemplary embodiment of the invention, the diffusion barrier region is a diffusion barrier layer or a number of diffusion barrier layers located between a plurality of the undoped layers.

An alternative aspect of the invention provides a method of manufacturing the previously mentioned electronic device. The method includes (1) forming an active region over a substrate, (2) forming an undoped layer over the active region, and (3) forming a doped upper cladding layer over the undoped layer, wherein a diffusion barrier region including aluminum is located between the undoped layer and the doped upper cladding layer. Also included in the present invention, is an optical fiber communications system. The optical fiber communication system, in an advantageous embodiment, includes an optical fiber, a transmitter and a receiver connected by the optical fiber, and the electronic device illustrated above.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

The invention is best understood from the following detailed description when read with the accompanying FIGUREs. It is emphasized that in accordance with the standard practice in the electronic industry, various features may not be drawn to scale. In fact, the dimensions of the various features may be arbitrarily increased or reduced for clarity of discussion. Reference is now made to the following descriptions taken in conjunction with the accompanying drawings, in which:

FIG. 1 illustrates one embodiment of a completed electronic device, taught herein;

FIG. 2 illustrates the formation of a partially completed electronic device including a substrate, a lower cladding layer, an active region, an undoped layer and a diffusion barrier region;

FIG. 3 illustrates the partially completed electronic device illustrated in FIG. 3 after formation of an upper cladding layer;

FIG. 4 illustrates a graph showing the benefits of a diffusion barrier region including multiple diffusion barrier layers;

FIG. 5 illustrates a graph showing the benefits of a diffusion barrier region including a single diffusion barrier layer;

FIG. 6 illustrates an optical fiber communication system, which forms one environment where the completed electronic device may be used; and

FIG. 7 illustrates an alternative embodiment optical fiber communication system, including a repeater.

### DETAILED DESCRIPTION

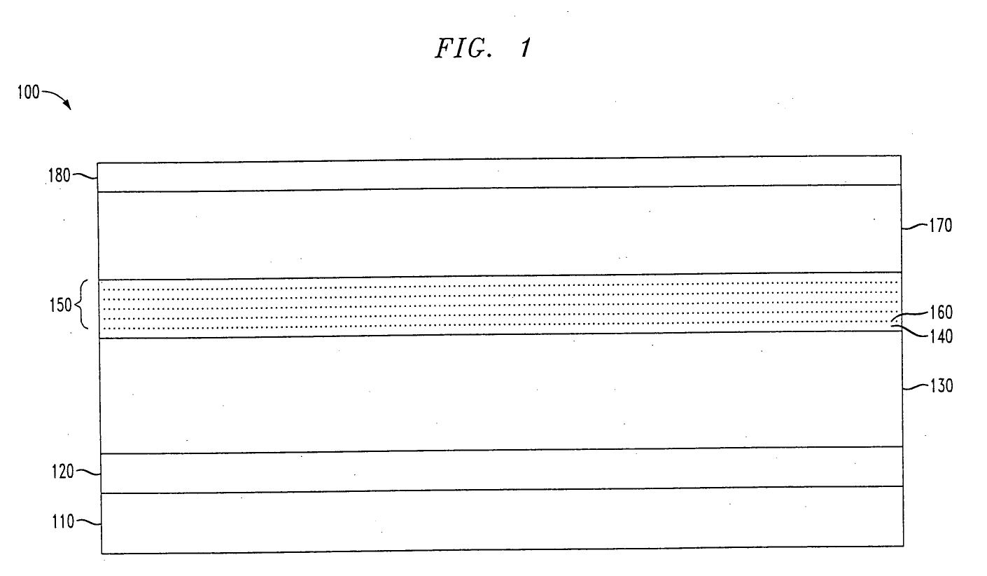

Referring initially to FIG. 1, illustrated is a cross-sectional view of one embodiment of an electronic device 100, as disclosed herein. The present invention is broadly directed to an electronic device 100 made of any material or compound that may have use in such devices. In the illustrative embodiments described herein, the electronic device 100 is specifically discussed as a group III-V based device, for example an indium phosphide/indium gallium arsenide phosphide based device, a gallium arsenide based device, an aluminum gallium arsenide based device, or another group III-V based device. However, even though the present invention is discussed in the context of a group III-V based device, it should be understood that the present invention is not limited to group III-V compounds and that other compounds located outside groups III-V may be used.

The illustrative embodiment of the electronic device 100 includes a substrate 110, a lower cladding layer 120 and a conventional active region 130. The electronic device further includes an undoped layer 140 located over the active region 130. Located over the undoped layer 140 is a diffusion barrier region 150 including aluminum. In the illustrative embodiment shown in FIG. 1, the diffusion barrier region 150 includes a diffusion barrier layer 160, or a number of diffusion barrier layers 160 located between a plurality of undoped layers 140. In an exemplary embodiment, the diffusion barrier layers 160 may comprise aluminum diffusion barrier layers. Further included within the electronic device 100 is a doped upper cladding layer 170 with a contact layer 180 located thereover.

The undoped layer 140 and the diffusion barrier region 150 substantially reduce the amount of diffusion of the dopant located within the upper cladding layer 170, into the active region 130. As a result of the substantially reduced diffusion of the upper cladding layer dopant into the active region 130, the electronic device does not experience degradation of its device characteristics, as experienced by the prior art electronic devices discussed above. Moreover, this is accomplished while maintaining precise control over the p-n junction placement and background doping in the active region 130, which is in contrast to the prior art structures. The use of the undoped layer 140 and diffusion barrier region 150 also allows for optimal design of the upper cladding layer 170 and contact layer 180, without being concerned with the zinc diffusion, and the detrimental effects the zinc diffusion has on device performance. Additionally, the diffusion barrier region 150 may have a thickness, which in certain embodiments may be less than about 40 nm, that is substantially less than the thickness of some of the prior art devices. This is particularly important as it becomes increasingly important for the p-n junction to reside within the active region 130.

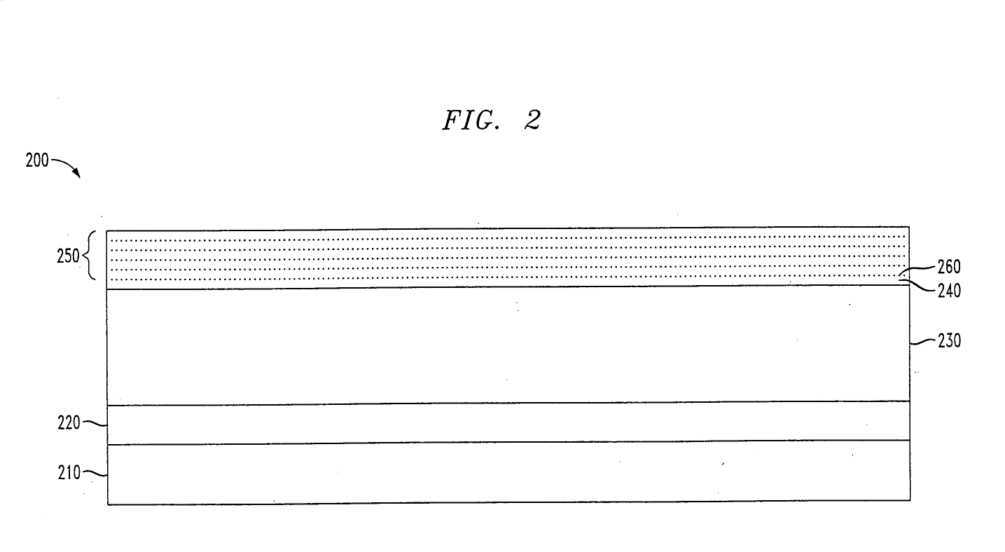

Turning to FIGS. 2-4, with continued reference to FIG. 1, illustrated are various intermediate stages of the manufacture of the electronic device 100 of FIG. 1. FIG. 2 illustrates a cross-sectional view of a partially completed electronic device 200. The partially completed electronic device 200 illustrated in FIG. 2, includes a lower cladding layer 220, which in a previous step (not shown) was formed over a substrate 210. The substrate 210 may be any layer located in an electronic device, including a layer located at the wafer level or a layer located above or below the wafer level. The substrate 210, in an exemplary embodiment, is a highly n-doped indium phosphide (InP) substrate.

As previously mentioned, located over the substrate 210 may be the lower cladding layer 220. The lower cladding layer 220, in the illustrative embodiment, is an n-doped InP cladding layer. It should be understood that the lower cladding layer 220 is not limited to an n-doped InP layer, and that other materials, doped or undoped, may be used. An active region 230 may be located over the substrate 210 and lower cladding layer 220. The active region 230, as previously mentioned during the discussion of FIG. 1, may be a quantum well region, and may, in an exemplary embodiment, include separate confining layers (not shown). In an exemplary embodiment of the invention, the active region 230 includes materials chosen from group III-V compounds. The active region 230 is typically intentionally not doped, however, in an alternative embodiment it may be doped as long as the p-n junction placement is taken into consideration. The substrate 210, lower cladding layer 220 and the active region 230, may all be formed by conventional processes.

Further illustrated in FIG. 2 is an undoped layer 240 formed over the active region 230. In the illustrated embodiment, the undoped layer 240 is formed directly on the active region 230, however, this may not always be the case. The undoped layer 240, in an exemplary embodiment, may be an indium phosphide undoped layer. Likewise, in an alternative exemplary embodiment, the undoped layer 240 may have a thickness of about 10 nm and may act as a protective layer from subsequent processing steps.

Also located within the partially completed electronic device 200 is a diffusion barrier region 250 including aluminum, formed over the undoped layer 240. The diffusion barrier region 250 may be a single diffusion barrier layer 260 interposed between the previously described undoped layer 240 and a subsequently formed undoped layer 240. Likewise, in the illustrative embodiment shown in FIG. 2, the diffusion barrier region 250 may comprise a number of diffusion barrier layers 260, such as aluminum diffusion barrier spikes, located between a plurality of undoped layers 240. In an alternative embodiment of the invention, the diffusion barrier layer 260 may consist of aluminum arsenide, aluminum phosphide, indium aluminum arsenide, indium aluminum arsenide phosphide, or indium aluminum gallium arsenide. In an exemplary embodiment of the invention, aluminum within the diffusion barrier layer ranges from about 5 to about 50 percent.

Generally, the number of diffusion barrier layers required to substantially prevent zinc from diffusing from an upper cladding layer, formed in a subsequent step, to the active region 230, depends on the desired dopant concentration, for instance zinc concentration, and thickness of the upper cladding layer. In an exemplary embodiment where the desired dopant concentration (zinc concentration) of the upper cladding layer is about 1.8E18 atoms/cm³, about 6 diffusion barrier layers, each diffusion barrier layer having a thickness of about 1 nm, may provide an effective barrier for zinc diffusion. In such an embodiment, the undoped layers interposed between the diffusion barrier layers might have a thickness of about 10 nm. It should be noted that the number of diffusion barrier layers may vary from device to device, including a number ranging from about 1 to about 8 diffusion barrier layers.

The undoped layer 240 and the diffusion barrier region 250 may be formed using conventional deposition processes, such as a metalorganic vapor-phase epitaxy (MOVPE), molecular beam epitaxy (MBE), liquid phase epitaxy (LPE), or another similar epitaxial process. In an exemplary embodiment, the undoped layer 240 and the diffusion barrier region 250 are formed in the same process chamber. For example, in one advantageous embodiment the partially completed electronic device 200, including the exposed active region 230, may be placed within a MOCVD process chamber and the undoped layer 240 may begin being formed. After the undoped layer 240 is formed to a thickness of about 10 nm, an aluminum containing source gas of trimethyl aluminum or triethyl aluminum may be included within the chamber while continuing to form the undoped layer. The source gas may be applied for a period of time ranging from about 10 seconds to about 100 seconds, or until the diffusion barrier layer 260 containing aluminum and having a thickness of about 1 nm is formed. Subsequent to forming the diffusion barrier layer 260, the source gas may be removed and an additional undoped layer having a thickness of about 10 nm may be formed. The above-mentioned iterative process may continue until a desired number of diffusion barrier layers 260 and undoped layers 240 have been formed. In one advantageous embodiment, the MOVPE growth method may be conducted at a temperature ranging from about 530° C. to about 700° C. and a growth chamber pressure ranging from about 20 mbar to about atmospheric pressure. It should be noted, however, that the process parameters required to manufacture the device 200 may vary without departing from the scope of the present invention.

In an alternative exemplary embodiment, the partially completed electronic device 200, including the exposed active region 230, may be placed within a MBE process chamber. Similar to the MOVPE method disclosed above, the partially completed electronic device 200 may be, after the initial undoped layer 240 has reached a thickness of about 10 nm, subjected to a solid aluminum source for a specified amount of time, thus forming the diffusion barrier layer 260. The process would again continue until the required number of diffusion barrier layers 260 and interposed undoped layers 240 have been formed. In one embodiment, the MBE may be conducted at a temperature ranging from about 400° C. to about 500° C. and a growth chamber pressure of less than about 1E-9 mbar. Similar to above, the process parameters required to manufacture the device 100 may vary.

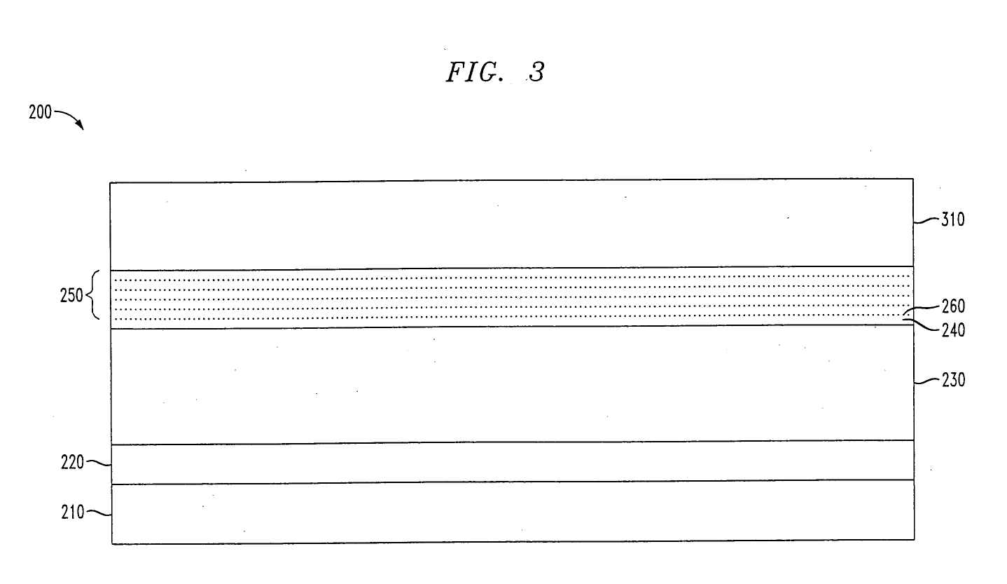

Turning to FIG. 3, illustrated is the partially completed electronic device 200 illustrated in FIG. 2, after formation of an upper cladding layer 310. The upper cladding layer 310, in an exemplary embodiment, is an indium phosphide cladding layer having a dopant formed therein. The dopant is typically a p-type dopant such as zinc; however, one having skill in the art understands that other dopants, such as cadmium, beryllium and magnesium may be used in this capacity. It is the dopant located within the upper cladding layer 310 that the undoped layer 240 and the diffusion barrier region 250 prevent from diffusing into the active region 230. The upper cladding layer 310 may be formed using a conventional epitaxial process, for example a metalorganic vapor-phase epitaxy, or other similar process. After formation of the upper cladding layer 310, a capping layer 170 (FIG. 1) may be conventionally formed, resulting in the completed electronic device 100 illustrated in FIG. 1.

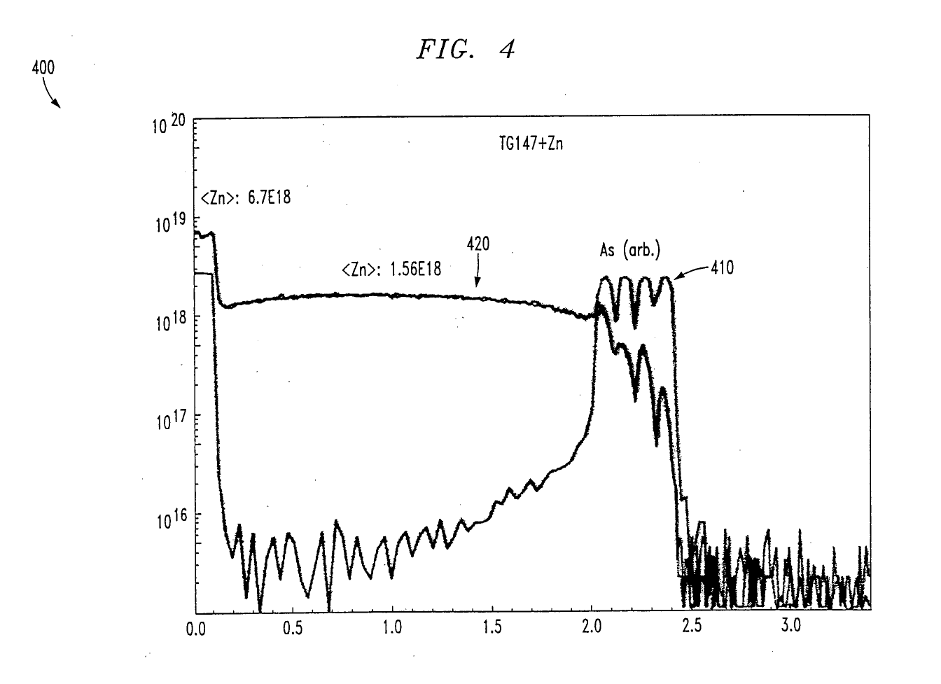

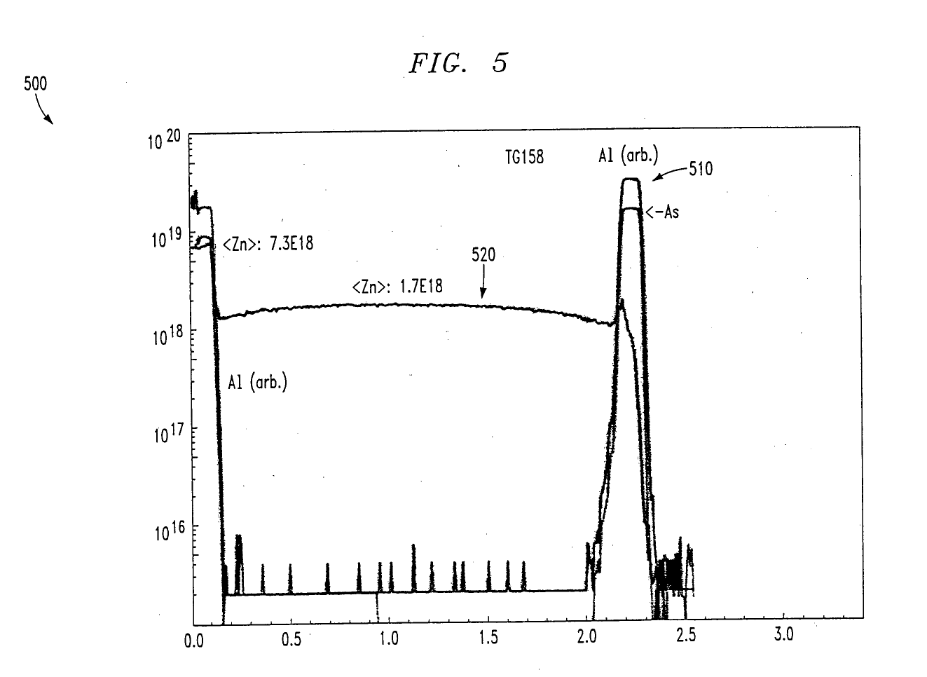

Turning briefly to FIGS. 4 and 5, illustrated are two Secondary Ion Mass Spectrometry (SIMS) images 400, 500, which illustrate the concentration versus depth of the zinc diffusion within the completed electronic device 100 illustrated in FIG. 1. As can be noticed in the graph 400 illustrated in FIG. 4, the inclusion of aluminum arsenide diffusion barrier layers 410 within the device, substantially prevents zinc 420 from diffusing thereunder. Likewise, as shown in the graph 500 illustrated in FIG. 5, the single higher concentration aluminum diffusion barrier layer 510 also substantially prevents the zinc 520 from diffusing thereunder.

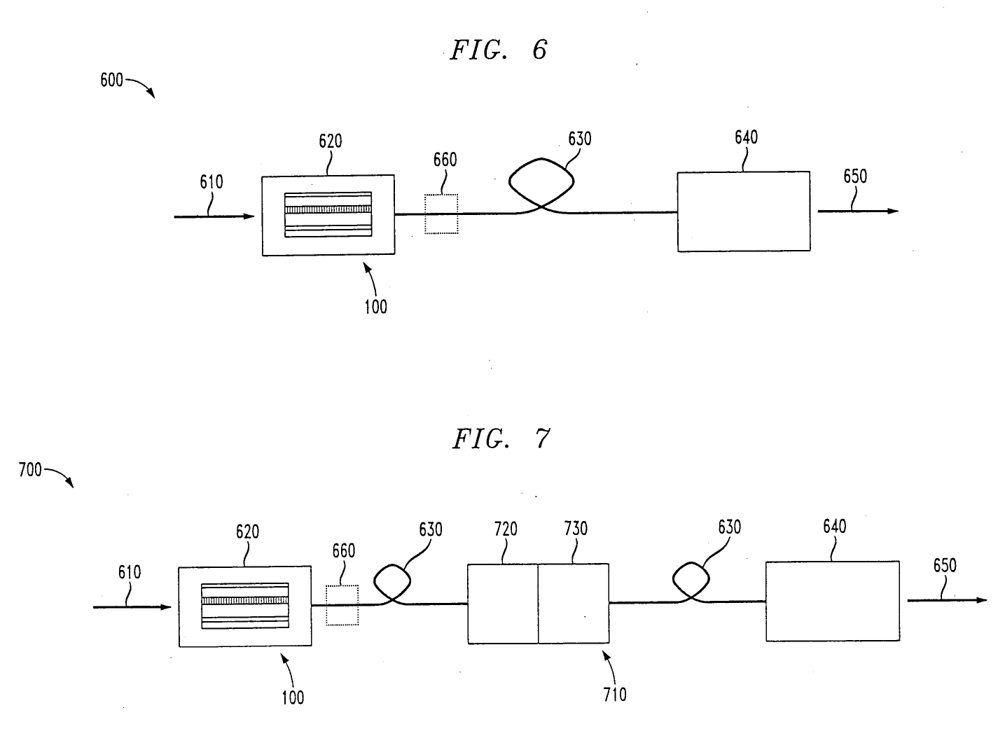

Turning briefly to FIG. 6, illustrated is an optical fiber communication systems 600, which may form one environment where the completed electronic device 100 may be included. The optical fiber communication system 600, in the illustrative embodiment, includes an initial signal 610 entering a receiver 620. The receiver 620, receives the initial signal 610, addresses the signal 610 in whatever fashion desired, and sends the resulting information across an optical fiber 630 to a transmitter 640. The transmitter 640 receives the information from the optical fiber 630, addresses the information in whatever fashion desired, and sends an ultimate signal 650. As illustrated in FIG. 6, the completed electronic device 100 may be included within the receiver 620. However, the completed electronic device 100 may also be included anywhere in the optical fiber communication system 600, including the transmitter 640. The optical fiber communication system 600 is not limited to the devices previously mentioned. For example, the optical fiber communication system 600 may include a source 660, such as a laser or a diode. Turning briefly to FIG. 7, illustrated is an alternative optical fiber communication system 700, having a repeater 710, including a second receiver 720 and a second transmitter 730, located between the receiver 620 and the transmitter 640.

Although the present invention has been described in detail, those skilled in the art should understand that they can make various changes, substitutions and alterations herein without departing from the spirit and scope of the invention in its broadest form.

What is claimed is:

1. An electronic device, comprising:
an active region located over a substrate;
an undoped layer located over the active region; and
a doped upper cladding layer located over the undoped layer, wherein a diffusion barrier region including aluminum is located between the undoped layer and the doped upper cladding layer.

2. The electronic device as recited in claim 1 wherein the diffusion barrier region is a diffusion barrier layer or a number of diffusion barrier layers located between a plurality of the undoped layers.

3. The electronic device as recited in claim 2 wherein the number of diffusion barrier layers ranges from about 1 to about 8 layers and each of the number of diffusion barrier layers has a thickness of about 1 nm.

4. The electronic device as recited in claim 1 wherein the diffusion barrier region includes an diffusion barrier layer consisting of aluminum arsenide, aluminum phosphide, indium aluminum arsenide, indium aluminum arsenide phosphide, or indium aluminum gallium arsenide.

5. The electronic device as recited in claim 4 wherein the diffusion barrier layer comprises between about 5 and about 50 percent aluminum.

6. The electronic device as recited in claim 1 wherein the diffusion barrier region has a thickness of about 1 nm and the undoped layer has a thickness of about 10 nm.

7. The electronic device as recited in claim 1 wherein the diffusion barrier region does not form a p-n junction with the doped upper cladding layer.

8. The electronic device as recited in claim 1 wherein the doped upper cladding layer is doped with zinc and the diffusion barrier region inhibits the diffusion of zinc into the active region.

9. A method of manufacturing an electronic device, including:
forming an active region over a substrate;
forming an undoped layer over the active region; and
forming a doped upper cladding layer over the undoped layer, wherein a diffusion barrier region including aluminum is formed between the undoped layer and the doped upper cladding layer.

10. The method as recited in claim 9 wherein the diffusion barrier region is a diffusion barrier layer or a number of diffusion barrier layers located between a plurality of the undoped layers.

11. The method as recited in claim 10 wherein the number of diffusion barrier layers ranges from about 1 to about 8 layers and each of the number of diffusion barrier layers has a thickness of about 1 nm.

12. The method as recited in claim 9 wherein the diffusion barrier region includes an aluminum diffusion barrier layer consisting of aluminum arsenide, aluminum phosphide, indium aluminum arsenide, indium aluminum arsenide phosphide, or indium aluminum gallium arsenide.

13. The method as recited in claim 12 wherein the diffusion barrier layer comprises between about 5 and about 50 percent aluminum.

14. The method as recited in claim 9 wherein the diffusion barrier region has a thickness of about 1 nm and the undoped layer has a thickness of about 10 nm.

15. The method as recited in claim 9 wherein the diffusion barrier region does not form a p-n junction with the doped upper cladding layer.

16. The method as recited in claim 9 wherein forming a doped upper cladding layer includes forming a zinc doped upper cladding layer, wherein the diffusion barrier region inhibits the diffusion of zinc from the upper cladding layer into the active region.

17. An optical fiber communications system, comprising:
an optical fiber;
a transmitter and a receiver connected by the optical fiber; and
an electronic device, including:
an active region located over a substrate;
an undoped layer located over the active region; and
a doped upper cladding layer located over the undoped layer, wherein a diffusion barrier region including aluminum is located between the undoped layer and the doped upper cladding layer.

18. The optical fiber communication system recited in claim 17 wherein the diffusion barrier region is a diffusion barrier layer or a number of diffusion barrier layers located between a plurality of the undoped layers.

19. The optical fiber communication system recited in claim 17 wherein the transmitter or the receiver includes the electronic device.

20. The optical fiber communication system recited in claim 17 further including a source or a repeater.
